(19) United States
(12) Patent Application Publication
(10) Pub. No.: US 2019/0113158 A1
(43) Pub. Date: Apr. 18, 2019

(54) LIGHTWEIGHT COMPOSITES TUBES FOR HIGH PRESSURE AEROSPACE HYDRAULIC APPLICATION

(71) Applicant: Eaton Intelligent Power Limited, Dublin 4 (IE)

(72) Inventors: Zhou Zhou, Farmington Hills, MI (US); Javed A. Mapkar, Northville, MI (US); Richard M. de Luna, Fontana, CA (US); Anthony O'Meara, Ann Arbor, MI (US); Gerry M. Berard, North Providence, RI (US)

(21) Appl. No.: 16/156,301

(22) Filed: Oct. 10, 2018

Related U.S. Application Data
(60) Provisional application No. 62/571,868, filed on Oct. 13, 2017.

(51) Int. Cl. F16L 11/08; B29C 47/00; B29C 70/38

(52) U.S. Cl. CPC F16L 11/081; B29C 47/0023; B29K 2307/04; B29C 70/386; B29C 47/0059

(57) ABSTRACT

A fluid conduit includes a first portion and a second portion disposed at least partially around the first portion. The first portion may include an extruded thermoplastic. The second portion may include a plurality of layers formed via fiber reinforced thermoplastic tape, tows, and/or fabric. The first portion and the second portion may be substantially rigid and may include concentric cylindrical cross-sections. The fiber reinforced thermoplastic tape, tows, and/or fabric may include nano-additives and/or micro-additives.

### CROSS-REFERENCE TO RELATED APPLICATION

This application claims the benefit of U.S. Provisional Patent Application Ser. No. 62/571,868 filed on Oct. 13, 2017, the disclosure of which is hereby incorporated herein by reference in its entirety.

### TECHNICAL FIELD

The present disclosure generally relates to fluid conduits, including tubes that may be used in connection with high pressure aerospace hydraulic applications.

### BACKGROUND

This background description is set forth below for the purpose of providing context only. Therefore, any aspect of this background description, to the extent that it does not otherwise qualify as prior art, is neither expressly nor impliedly admitted as prior art against the instant disclosure.

Some fiber reinforced structures may be used in connection with flexible conveyance parts like hydraulic hoses. However, such structures may not be rigid enough for some rigid metal tube applications (e.g., to replace rigid metal tubes). To replace metallic tubes, composites tubes may need to be fluid impermeable, have sufficient mechanical properties to withstand static and dynamic loads, and be capable of being formed with three-dimension geometries that are currently obtained by bending or welding for metallic tubes. However, with some fabrication methods to produce such fiber-reinforced polymer composites, specific molds for each geometry, inflatable bags, or shrink wraps to heat and compress the initial tube preform into consolidated state may be involved, which may involve relatively high cost, long processing time, and/or intensive labor.

There is a desire for solutions/options that minimize or eliminate one or more challenges or shortcomings of fluid conduits and methods of forming fluid conduits. The foregoing discussion is intended only to illustrate examples of the present field and should not be taken as a disavowal of scope.

### SUMMARY

In embodiments, a fluid conduit may include a first portion and a second portion disposed at least partially around the first portion. The first portion may include an extruded thermoplastic. The second portion may include a plurality of layers formed via fiber reinforced thermoplastic tapes, tows, and/or fabrics. The first portion and the second portion may be substantially rigid and fluid impermeable, and may include concentric cylindrical cross-sections. The fiber reinforced thermoplastic tape, tows, and/or fabric may include nano-additives and/or micro-additives.

With embodiments, a method of forming a fluid conduit may include extruding a first portion of the fluid conduit with thermoplastic, providing fiber reinforced thermoplastic material, including tape, tows and/or fabric, and laying a plurality of layers of the fiber reinforced thermoplastic material on top of the first portion to form a second portion of the fluid conduit.

The foregoing and other aspects, features, details, utilities, and/or advantages of embodiments of the present disclosure will be apparent from reading the following description, and from reviewing the accompanying drawings.

### BRIEF DESCRIPTION OF THE DRAWINGS

FIG. 1 is a cross-sectional view generally illustrating an embodiment of a fluid conduit according to teachings of the present disclosure.

FIG. 2 is a flow diagram generally illustrating an embodiment of a method of forming a fluid conduit according to teachings of the present disclosure.

FIG. 3 is a side view generally illustrating embodiments of a fluid conduit and forming equipment according to teachings of the present disclosure.

FIG. 4 is a side view generally illustrating embodiments of a bent fluid conduit and forming equipment according to teachings of the present disclosure.

FIG. 5 is a side view generally illustrating an embodiment of a fluid conduit according to teachings of the present disclosure.

### DETAILED DESCRIPTION

Reference will now be made in detail to embodiments of the present disclosure, examples of which are described herein and illustrated in the accompanying drawings. While the present disclosure will be described in conjunction with embodiments and/or examples, it will be understood that they are not intended to limit the present disclosure to these embodiments and/or examples. On the contrary, the present disclosure is intended to cover alternatives, modifications, and equivalents.

Composites materials may be utilized in connection with airplane structure, components, and systems for their structural efficiency. Aircraft may include carbon fiber composites for the skin and airframe structure instead of metal materials. The design of fluid conveyance systems (including hydraulic, fuel, and environmental control systems (ECS)-hydraulic return, liquid cooling) using composites to replace current metal materials can further lower weight to reduce fuel burn and emission, reduce the electrical conductivity of the pipelines to prevent lightning strike risks while remaining sufficiently conductive to dissipate electrical static charge, as well as mitigate the design complexity of integrating metallic and composites materials to ensure necessary system safety.

In embodiments, a fluid conduit 10 may include a rigid multilayer multi-functional thermoplastic composite tube that may be leak proof and/or may include tailored electrical properties to be electrostatic and lightning compatible. A method 100 of forming a fluid conduit 10 may include an in-situ consolidation additive manufacturing automated tape layup process. The method 100 may include bending the fluid conduit 10.

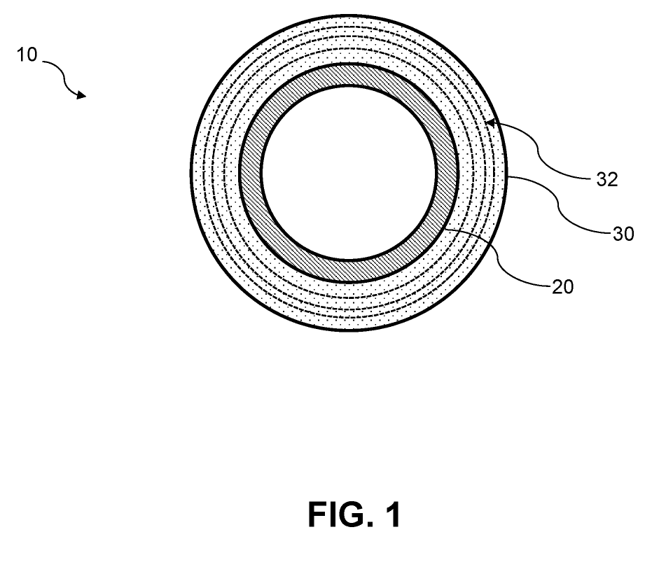

With embodiments, such as generally illustrated in FIG. 1, a fluid conduit 10 may include a first portion 20 and/or a second portion 30. The first portion 20 may include, for example and without limitation, an inner fluid impermeable extrusion layer. The first portion 20 may include one or more nano-additives and/or one or more micro-additives. Nano-additives and/or micro-additives may be configured to facilitate dissipation of electrostatic charge, make the fluid conduit 10 electrostatic, and/or make the fluid conduit 10 lightning compatible.

In embodiments, a second portion 30 may include, for example and without limitation, one or more fiber reinforcement layers 32. The one or more fiber reinforcement layers 32 may be formed via laying up tape and/or or films. The layup angle, number of plies, and/or thickness of the reinforcement layers 32 may be adjusted to achieve the pressure requirements of specific application. In embodiments, certain sections of the second portion 30 may include additional layers 32, such as to provide additional localized reinforcement. Fibers of the fiber reinforcement layers 32 may be pre-impregnated with a thermoplastic matrix, which may be compounded with nano-additives and/or micro-additives, such as to adjust electrical conductivity.

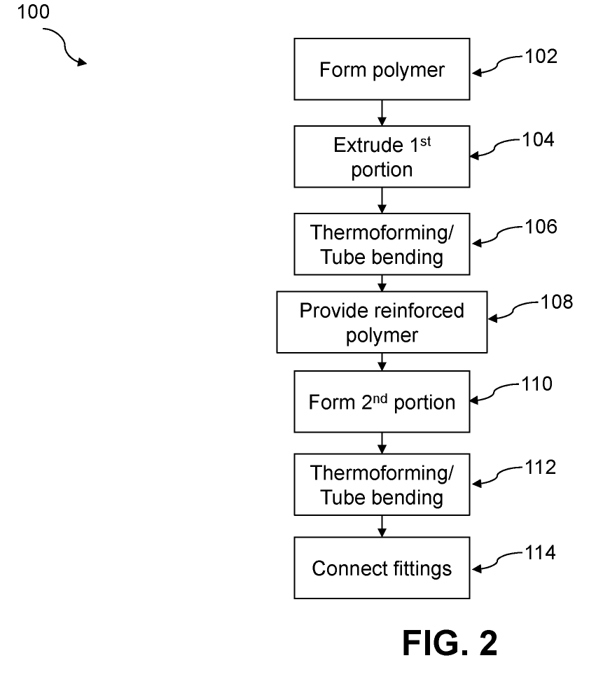

With embodiments, such as generally illustrated in FIG. 2, a method 100 of producing a fluid conduit 10 may include providing and/or forming a thermoplastic polymer (step 102). The method 100 may include extruding the first/inner portion 20 with the thermoplastic polymer (step 104), which may include nano-fillers and/or micro-fillers. The method 100 may include providing fiber reinforced thermoplastic materials (step 108), such as tape, tows, and/or fabrics, which may be filled with nano-additives and/or micro-additives. The method 100 may include adding/forming a second portion 30 (step 110), such as via laying the fiber reinforcement materials on top of the extruded first portion 20 in a plurality of layers 32.

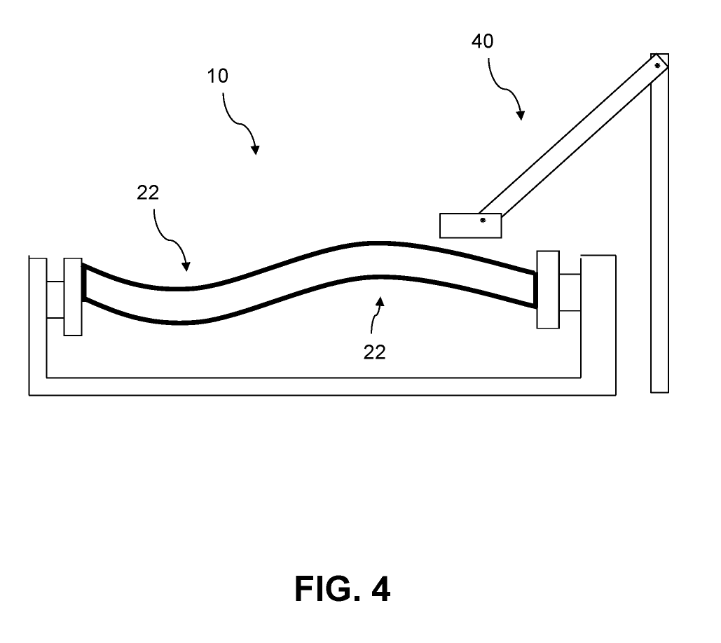

In embodiments, the method 100 may, after extruding the first portion 20 in step 104, include (i) heating the first portion 20 to a softening stage, (ii) forming the first portion 20 into a first bent geometry (see, e.g., the bent geometry generally illustrated in FIG. 4), and/or (iii) cooling the first portion 20 to retain the first bent geometry (step 106). Adding the second portion 30 in step 110 may then include disposing layers 32 of the fiber reinforcement materials on top of the bent first portion 20. Forming the first portion 20 into a first bent geometry may include providing the first portion 20 and/or the fluid conduit 10 with one or more bends 22.

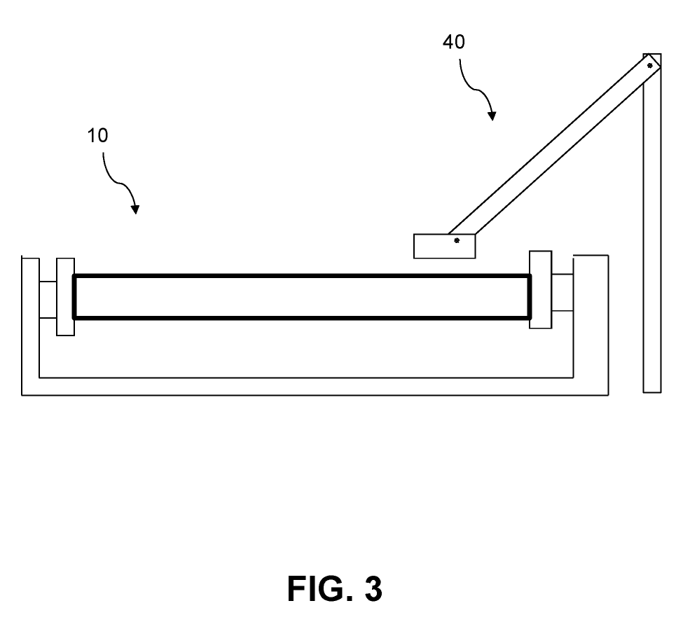

With embodiments, adding the second portion in step 110 may include disposing/forming layers 32 of the fiber reinforcement materials via automated tape layup equipment 40 (see, e.g., FIGS. 3 and 4). The automated tape layup equipment 40 may be configured apply heat and pressure at the same time for in-situ consolidation. The fiber reinforcement materials may be resin-rich.

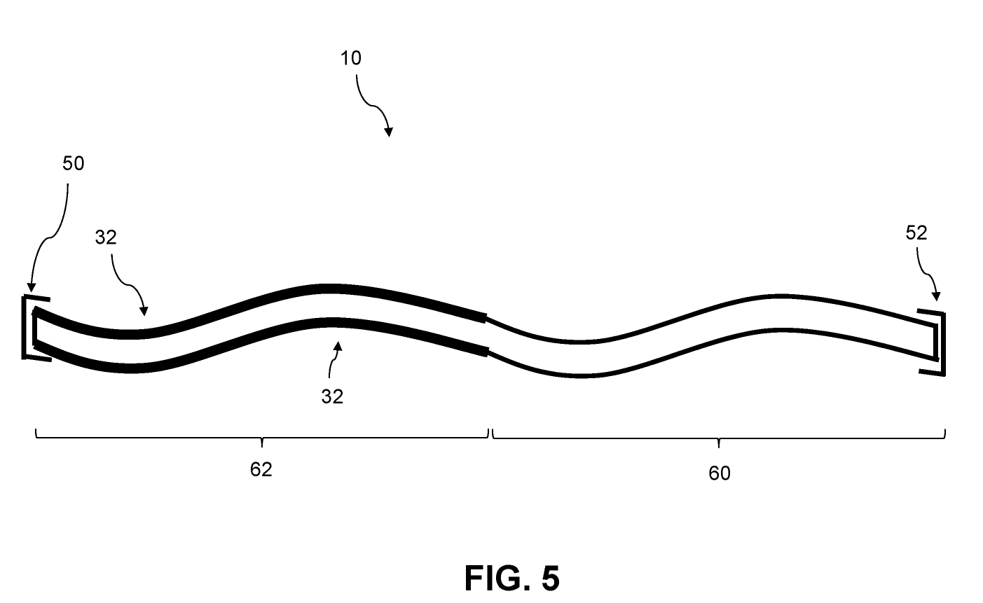

In embodiments, the method 100 may, after forming the second portion 30 in step 110, include (i) heating the first portion 20 and second portion 30 (e.g., the fluid conduit 10) to a softening temperature, (ii) bending the first portion 20 and the second portion 30 to a second desired geometry/shape (see, e.g., the bent geometry generally illustrated in FIG. 5), and (iii) cooling the first portion 20 and the second portion 30 to retain the second desired/formed geometry (step 112). Bending the first portion 20 and/or the second portion 30 may provide the fluid conduit 10 with one or more bends 34.

With embodiments, the method 100 may, after forming the second portion 30 in step 110, include adding a first fitting 50 to a first end of the fluid conduit 10 and/or adding a second fitting 52 to a second end of the fluid conduit 10 (step 114).

In embodiments, the first portion 20 and/or the second portion 30 may include one or more of a variety of shapes, sizes, and/or configurations. For example and without limitation, the first portion 20 and/or the second portion 30 may include generally cylindrical shapes/cross-sections that may be disposed concentrically with each other. The first portion 20 and/or the second portion 30 may be substantially rigid.

With embodiments, heating methods, such as those that may be used to heat a first portion 20 and/or a second portion 30 to a softening temperature, may include hot gas, flame, ultrasonic heating, infrared heating, induction heating, and/or or laser heating. The automated tape layup equipment 40 may be configured to provide heat via one or more of these methods.

In embodiments, the second portion 30 may include a plurality of layers 32 that may be disposed on the first portion 20. For example and without limitation, the second portion 30 may include at least five layers 32, and may, for instance, include eight layers. The layers 32 may be provided via a +55/−55 layup. With embodiments, such as generally illustrated in FIG. 5, a fluid conduit 10 may have a continuous first portion 20 surrounded over at least a portion thereof by a second portion 30, and may include a first section 60 and/or a second section 62. The first section 60 and second section may or may not have substantially similar lengths. The second portion 30 may include different numbers of layers 32 in the first section 60 and the second section 62. For example and without limitation, the second portion 30 may include a greater number of layers 32 in the second section 62 than in the first section 60, which may provide additional rigidity and/or strength to the fluid conduit 10 in the second section 62.

Embodiments of fluid conduits 10 may include improved rigidity and strength, and/or improved weight relative to other designs. For example and without limitation, an embodiment of a fluid conduit 10 may include a burst pressure of at least about 23,000 psi (e.g., about 23,600 psi, such as with a unidirectional carbon fiber embodiment), an outer diameter of about 0.5 inches, an inner diameter of about 0.37 inches, a thickness of about 0.065 inches, a density of about 1.5 g/cc, and/or a weight of about 90 g/m or less (e.g., about 85.65 g/m).

In embodiments, the thermoplastic first portion 20 may include one or more thermoplastic matrix materials, which may include, but are not limited to, polyetheretherektone (PEEK), polyacryletherketone (PAEK), Polyetherketoneketone (PEKK), polyetherketone (PEK), polyketone (PK), polyphenylenesulphide (PPS), polyethyleneimine (PEI), polyacrylamide (PA), polyimide, and/or combinations thereof.

With embodiments, nano-additives may include, but are not limited to, carbon nanotubes, carbon nanofiber, graphene, alumina, alumina nanotubes, aluminum nitride, boron nitride, boron nanotubes, nanoclay, nanodiamonds, titanium oxide, zirconium oxide, silicon carbide, silicon nanoparticles, aluminum oxide nanoparticles, and/or combinations thereof.

In embodiments, micro-additives may include, but are not limited to, carbon fiber, glass fiber, carbon black, talc, mica, basalt, and/or combinations thereof.

With embodiments, reinforcement materials that may be included in thermoplastic may include synthetic and/or natural fibers or filaments, which may include, but are not limited to, carbon fiber, glass fiber, poly-paraphenylene terephthalamide fiber (Kevlar), basalt fiber, ceramic fiber, and/or combinations thereof. Unidirectional continuous fiber form, chopped fiber, woven, braid fabric, and/or yarns may be used.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are intended to be inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

What is claimed is:

1. A fluid conduit, comprising:
a first portion; and
a second portion disposed at least partially around the first portion;
wherein the first portion includes an extruded thermoplastic;
wherein the second portion includes a plurality of layers formed via fiber reinforced thermoplastic tape, tows, and/or fabric.

2. The fluid conduit of claim 1, wherein the first portion and the second portion are substantially rigid and include concentric cylindrical cross-sections.

3. The fluid conduit of claim 1, wherein the fiber reinforced thermoplastic tape, tows, and/or fabric include nano-additives and/or micro-additives.

4. The fluid conduit of claim 3, wherein the nano-additives and/or micro-additives correspond to an electrical conductivity of the fluid conduit.

5. The fluid conduit of claim 1, wherein the fluid conduit includes a burst pressure of at least 23,000 psi.

6. The fluid conduit of claim 5, wherein the fluid conduit has a weight of about 90 grams per meter or less.

7. The fluid conduit of claim 6, wherein a combined thickness of the first portion and the second portion is about 0.065 inches.

8. The fluid conduit of claim 1, wherein the plurality of layers includes at least 5 layers.

9. The fluid conduit of claim 1, wherein the first portion and the second portion are rigid and include one or more bends.

10. The fluid conduit of claim 1, wherein the first portion and the second portion are substantially cylindrical and disposed concentrically with each other.

11. The fluid conduit of claim 1, wherein the second portion includes a first section having a first number of the plurality of layers; the second portion includes a second section having a second number of the plurality of layers; and the first number is different than the second number.

12. A method of forming a fluid conduit, the method comprising:
(a) extruding a first portion of the fluid conduit with thermoplastic;
(b) providing fiber reinforced thermoplastic material, including tape, tows and/or fabric; and
(c) laying a plurality of layers of the fiber reinforced thermoplastic material on top of the first portion to form a second portion of the fluid conduit.

13. The method of claim 12, wherein step (a) includes extruding the first portion with nano-additives and/or micro-additives.

14. The method of claim 12, wherein step (b) includes using an automated tape layup machine to apply heat and pressure at the same time for in-situ consolidation.

15. The method of claim 12, wherein applying heat in step (b) involves one or more of hot gas heating, flame heating, ultrasonic heating, infrared heating, induction heating, and/or laser heating.

16. The method of claim 12, including, after step (a):
heating the first portion to a softening state;
bending the first portion into a specific bent geometry; and
cooling the first portion to retain the specific bent geometry.

17. The method of claim 12, including, after step (c):
heating the first portion and the second portion to a softening temperature;
bending the first portion and the second portion to a desired shape; and
cooling the first portion and the second portion to retain the desired shape.

18. The method of claim 12, wherein the plurality of layers includes micro-additives and/or nano-additives that make the fluid conduit electrostatic and lightning compatible.

19. The method of claim 12, wherein step (c) includes laying a first number of layers of the plurality of layers on a first section of the first portion; laying a second number of layers of the plurality of layers on a second section; and the first number of layers is different than the second number of layers.

20. The method of claim 12, wherein the fluid conduit includes a burst pressure of at least 23,000 psi; the fluid conduit includes a combined weight of about 90 grams per meter or less; and a thickness of the fluid conduit is about 0.065 inches.
